(19) United States
(12) Patent Application Publication
(10) Pub. No.: US 2009/0289857 A1
(43) Pub. Date: Nov. 26, 2009

(54) PORTABLE ELECTRONIC DEVICE WITH A REPLACEABLE ANTENNA MODULE

(76) Inventors: Hung-Ming Huang, Taipei Hsien (TW); Chi-Chih Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/253,193

(22) Filed: Oct. 16, 2008

(30) Foreign Application Priority Data
May 26, 2008 (TW) 097209135

(51) Int. Cl. H01Q 1/24

(52) U.S. Cl. 343/702

(57) ABSTRACT

A portable electronic device includes a main body including a housing and a wireless communication module installed inside the housing for processing wireless signals. The portable electronic device further includes an antenna module connected to the housing at one end in a rotatable manner. The antenna module includes an antenna body for receiving and radiating wireless signals. At least one sunken part is formed on the antenna body. The antenna module further includes at least one elastic structure fixed inside the housing and wedged in the sunken part on the antenna body in an elastic deformation manner so as to fix the antenna body and the housing.

### BACKGROUND OF THE INVENTION

1. Field of the Invention

The present invention relates to a portable electronic device with a replaceable antenna module, and more particularly, to a portable electronic device utilizing an elastic structure for fixing an antenna body.

2. Description of the Prior Art

In modern society, data is required to be accessible anytime and anywhere. As such, wireless communication devices are the best choice. As technology progresses, portable wireless communication devices such as mobile phones and personal digital assistants (PDA) play an important role in modern life.

In each wireless communication device, an antenna used for receiving and transmitting radio waves is an important component. Especially in portable wireless communication devices, an antenna is not only required to be compact in size, but also required to coordinate with mechanical design. Besides, the antenna is required to have enough structural strength when the antenna is not only required to be compact in size, but also required to coordinate with mechanical design.

As for structural design of the antenna of a tablet computer, an antenna body is shielded by a metal housing resulting in signal reduction when the tablet computer is utilized in a tablet mode. A mechanical design for removing the antenna body from a shielding region of the metal housing can solve above-mentioned problem. However, the antenna might be broken when the tablet computer fails down carelessly. Addition, one end of the antenna body is screwed inside the metal housing so that a user can not replace the antenna easily especially when the antenna is broken.

### SUMMARY OF THE INVENTION

According to the claimed invention, a portable electronic device includes a main body including a housing and a wireless communication module installed inside the housing for processing wireless signals. The portable electronic device further includes an antenna module connected to the housing at one end in a rotatable manner. The antenna module includes an antenna body for receiving and radiating wireless signals. At least one sunken part is formed on the antenna body. The antenna module further includes at least one elastic structure fixed inside the housing and wedged in the sunken part on the antenna body in an elastic deformation manner so as to fix the antenna body and the housing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a portable electronic device according to a preferred embodiment of the present invention.

FIG. 2 is a functional block diagram of the portable electronic device according to the preferred embodiment of the present invention.

FIG. 3 is an exploded diagram of an antenna module and a main body located in different positions according to the preferred embodiment of the present invention.

FIG. 4 is an exploded diagram of the antenna module according to a first embodiment of the present invention.

FIG. 5 is a sectional view of an elastic structure fixing an antenna body according to the first embodiment of the present invention.

FIG. 6 is a sectional view of the elastic structure releasing the antenna body according to the first embodiment of the present invention.

FIG. 7 is an exploded diagram of the antenna module according to a second embodiment of the present invention.

FIG. 8 is a sectional view of an elastic structure fixing the antenna body according to the second embodiment of the present invention.

FIG. 9 is a sectional view of the elastic structure releasing the antenna body according to the second embodiment of the present invention.

### DETAILED DESCRIPTION

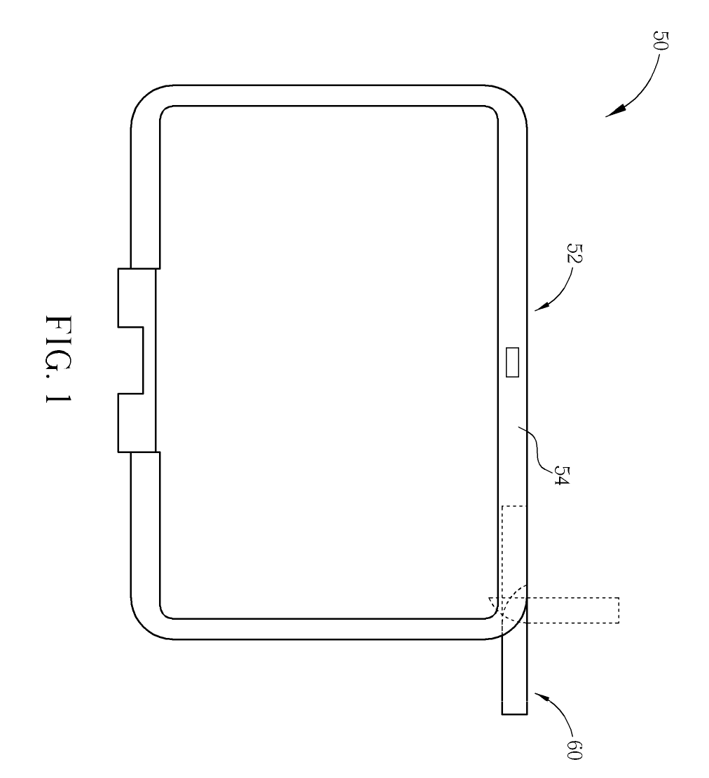

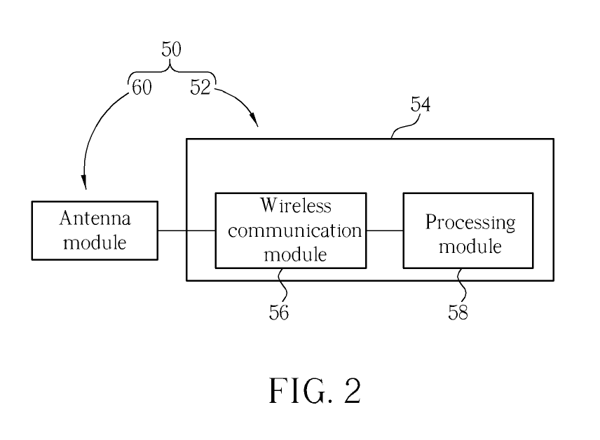

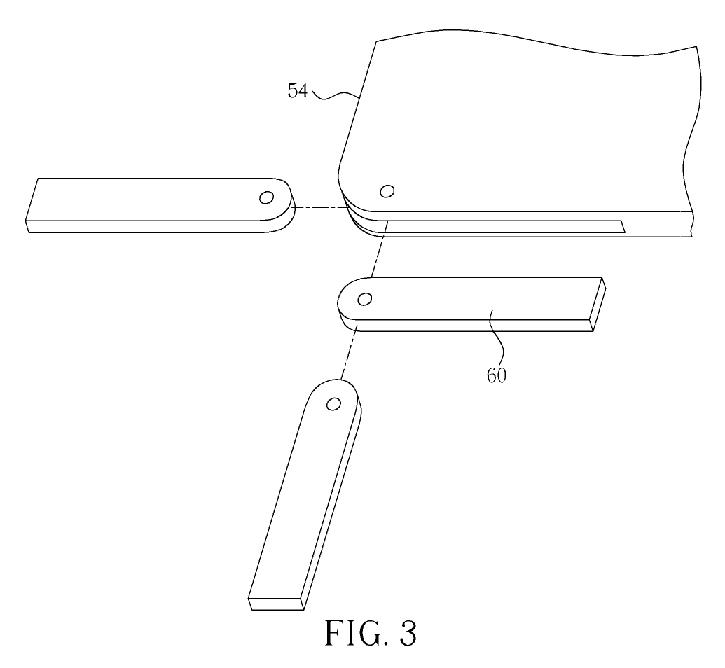

Please refer to FIG. 1 and FIG. 2. FIG. 1 is a schematic drawing of a portable electronic device 50 according to a preferred embodiment of the present invention. FIG. 2 is a functional block diagram of the portable electronic device 50 according to the preferred embodiment of the present invention. The portable electronic device 50 can be a portable computer, such as a notebook computer or a tablet computer. The portable electronic device 50 includes a main body 52 including a housing 54 for covering internal components of the portable electronic device 50. The portable electronic device 50 further includes a wireless communication module 56 installed inside the housing 54 for processing wireless signals, a processing module 58 electrically connected to the wireless communication module 56 for controlling operation of the portable electronic device 50, and an antenna module 60 connected to the housing 54 of the main body 52 at one end in a rotatable manner. Please refer to FIG. 3. FIG. 3 is an exploded diagram of the antenna module 60 and the main body 52 located in different positions according to the preferred embodiment of the present invention. When a user wants to utilize the portable electronic device 50 to receive wireless signals, the antenna module 60 can be rotated outside the main body 52. When the user does not utilize the portable electronic device 50 to receive wireless signals, the antenna module 60 can be rotated to be contained inside the housing 54 of the main body 52.

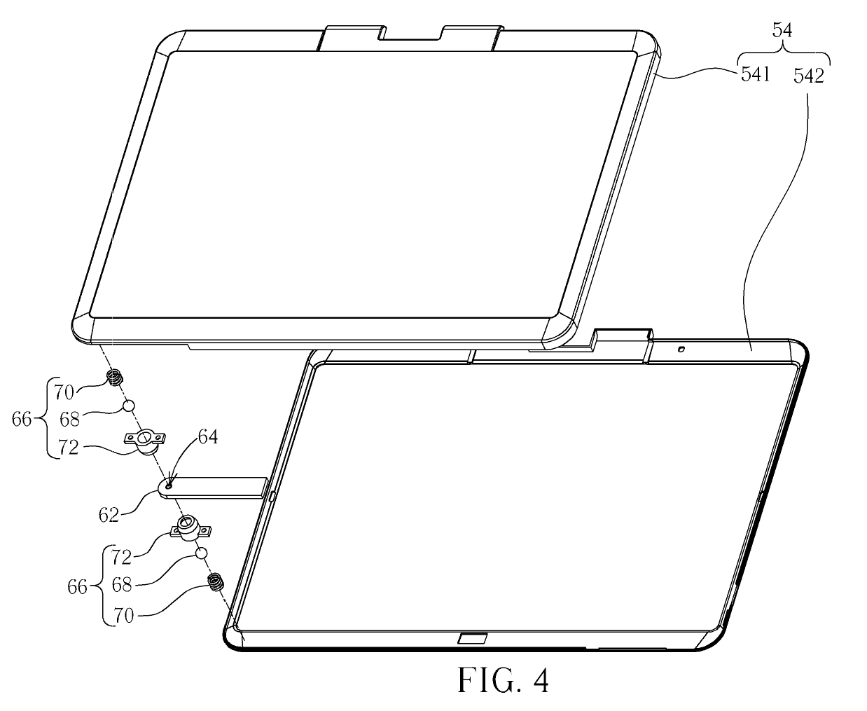

Please refer to FIG. 4. FIG. 4 is an exploded diagram of the antenna module 60 according to a first embodiment of the present invention. The housing 54 includes an upper casing 541 and a lower casing 542. The housing 54 can be a housing of a display module. The antenna module 60 can be contained between the upper casing 541 and the lower casing 542. The antenna module 60 includes an antenna body 62 for receiving and transmitting wireless signals. Sunken parts 64 are disposed on both lateral surface of the antenna body 62 respectively. The sunken part 64 can be an arc indentation. The antenna module 60 further includes elastic structures 66 fixed inside the housing 54 and disposed on both sides of the antenna body 62. Each elastic structure 66 includes a spherical component 68, an elastic component 70, and a fixing component 72. The structures of the two elastic structures 66 are symmetrical. The present invention also can use one set of the spherical component 68, the elastic component 70, and the fixing component 72. The number and the arrangement of the spherical component 68, the elastic component 70, and the fixing component 72 are not limited to this embodiment and can be designed according to demand.

The spherical component 68 is wedged inside the sunken part 64 so that the antenna body 62 is capable of being pivoted to the housing 54. The spherical component 68 can be a rigid body, such as a steel ball, so as to prevent being worn out easily when the antenna body 62 rotates relative to the housing 54. The elastic component 70 contacts with the spherical component 68 so as to provide an elastic force to the spherical component 68. The elastic component 70 can be a spring and connected to the spherical component 68 at one end. The spherical component 68 can be wedged in the elastic component 70. The elastic component 70 and the spherical component 68 can be made of conductive material, such as metal material. One end of the elastic component 70 is electrically connected to the wireless communication module 56 for transmitting wireless signals from the antenna body 62. That is, the antenna body 62 can be electrically connected to the wireless communication module 56 via the elastic component 70 and the spherical component 68. The antenna body 62 can be electrically connected to a grounding terminal via the elastic component 70 and the spherical component 62 for grounding. One end of the fixing component 72 is fixed on the housing 54. The fixing component 72 is for fixing the spherical component 68 and the elastic component 70. The fixing component 72 can be a sleeve, and the spherical component 68 and the elastic component 70 can be installed inside the sleeve in a movable manner.

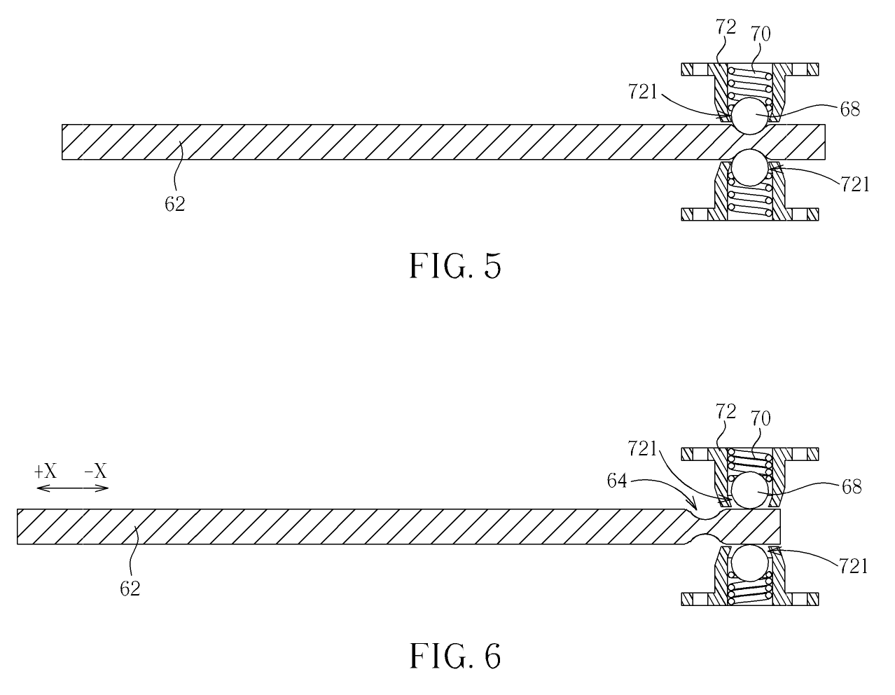

Please refer to FIG. 5 and FIG. 6. FIG. 5 is a sectional view of the elastic structure 66 fixing the antenna body 62 according to the first embodiment of the present invention. FIG. 6 is a sectional view of the elastic structure 66 releasing the antenna body 62 according to the first embodiment of the present invention. A diameter of an opening 721 at one end of the fixing component 72 is equal to or less than a diameter of the spherical component 68 substantially so that the spherical component 68 can not separate from the fixing component 72. As shown in FIG. 5, the elastic component 70 provides the elastic force to the spherical component 68 so that the spherical component 68 is wedged inside the sunken part 64 of the antenna body 62. The spherical component 68 is capable of constraining displacement of the antenna body 62, but the antenna body 62 still can rotate relative to the spherical component 68. The elastic structure 66 can fix the antenna body 62, and the antenna body 62 still can rotate relative to the housing 54. When the user wants to utilize the portable electronic device 50 to receive wireless signals, the antenna body 62 can be rotated outside the housing 54. When the user does not utilize the portable electronic device 50 to receive wireless signals, the antenna body 62 can be rotated to be contained inside the housing 54. In addition, the combination of the antenna body 62 and the elastic structure 66 is an elastic connection instead of a rigid connection, so the elastic structure 66 can absorb impulsive force when collision of the antenna body 62 occurs for reducing broken possibility of the antenna body 62.

As shown in FIG. 6, when the user wants to disassemble the antenna body 62 for repair or replacement, the antenna body 62 can be pulled out in X direction outwardly. At this time, the spherical component 68 compresses the elastic component 70 so that the spherical component 68 and the elastic component 70 move inwardly in the fixing component 72. As part of the spherical component 68 containing inside the fixing component 72 is increasing, the spherical component 68 can not wedge in the sunken part 64 of the antenna body 62. That is, the elastic structure 66 releases the antenna body 62, and one end of the antenna body 62 can not be fixed inside the housing 54. The user can pull out the antenna body 62 in X direction. On the other hand, when the user wants to assemble the antenna body 62 into the housing 54, the antenna body 62 can be pushed in −X direction inwardly. At this time, the spherical component 68 compresses the elastic component 70 so that the spherical component 68 and the elastic component 70 move inwardly in the fixing component 72. Part of the spherical component 68 containing inside the fixing component 72 is increasing until the spherical component 68 wedges in the sunken part 64 of the antenna body 62 so as to fix one end of the antenna body 62 inside the housing 54. The combination of the antenna body 62 and the elastic structure 66 is the elastic connection instead of the rigid connection so as to reduce difficulty of assembly of the antenna body 62.

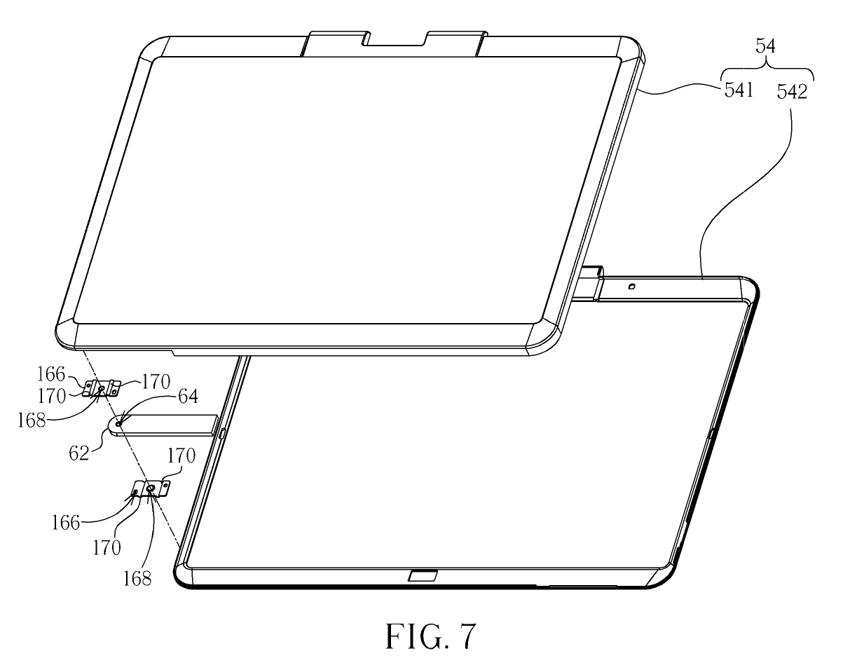

Please refer to FIG. 7. FIG. 7 is an exploded diagram of the antenna module 60 according to a second embodiment of the present invention. For simplicity, elements that have the same functions as that illustrated in the first embodiment are provided with the same item numbers used in the second embodiment. The difference between the second embodiment and the first embodiment is that the antenna module 60 includes elastic structures 166 fixed inside the housing 54 and disposed on both sides of the antenna body 62. The elastic structure 166 is a fragment. The structures of the two elastic structures 166 are symmetrical. The present invention also can use one set of the fragment. The number and the arrangement of the elastic structure 166 are not limited to this embodiment and can be designed according to demand.

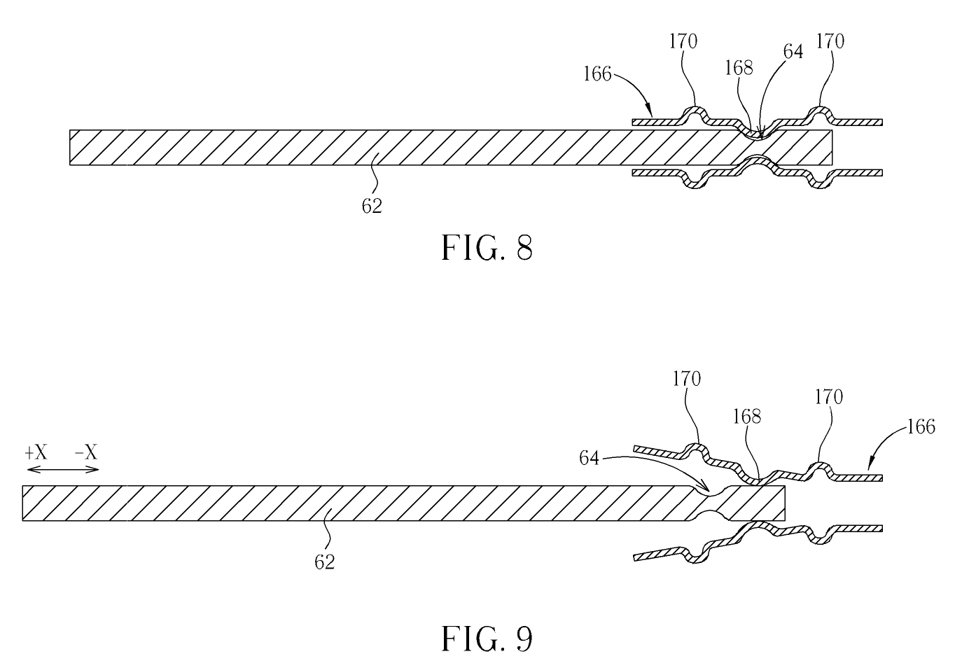

Please refer to FIG. 7 to FIG. 9. FIG. 8 is a sectional view of the elastic structure 166 fixing the antenna body 62 according to the second embodiment of the present invention. FIG. 9 is a sectional view of the elastic structure 166 releasing the antenna body 62 according to the second embodiment of the present invention. A protrusion 168 is disposed on a side of the elastic structure 166 for wedging in the sunken part 64 of the antenna body 62 so that the antenna body 62 can rotate relative to the housing 54. The protrusion 168 can be a spherical protrusion, and the sunken part 64 can be an arc indentation accordingly. At least one wave structure 170 is disposed on the other side of the elastic structure 166 for reducing rigidity of the elastic structure 166. That is, the elastic structure 166 can be deformed easily. The elastic structure 166 can be made of conductive material, such as metal material. The elastic component 166 can be electrically connected to the wireless communication module 56 for transmitting wireless signals from the antenna body 62. That is, the antenna body 62 can be electrically connected to the wireless communication module 56 via the elastic structure 166. The antenna body 62 can be electrically connected to a grounding terminal via the elastic structure 166 for grounding. As shown in FIG. 8, the protrusion 168 of the elastic structure 166 can be wedged inside the sunken part 64 of the antenna body 62 elastically so that the protrusion 168 is capable of constraining displacement of the antenna body 62, but the antenna body 62 still can rotate relative to the protrusion 168. The elastic structure 166 can fix the antenna body 62, and the antenna body 62 still can rotate relative to the housing 54. When the user wants to utilize the portable electronic device 50 to receive wireless signals, the antenna body 62 can be rotated outside the housing 54. When the user does not utilize the portable electronic device 50 to receive wireless signals, the antenna body 62 can be rotated to be contained inside the housing 54. In addition, the combination of the antenna body 62 and the elastic component 166 is the elastic connection instead of the rigid connection, so the elastic structure 166 can absorb impulsive force when collision of the antenna body 62 occurs for reducing broken possibility of the antenna body 62.

As shown in FIG. 9, when the user wants to disassemble the antenna body 62 for repair or replacement, the antenna body 62 can be pulled out in X direction outwardly. At this time, a surface of the antenna body 62 pushes the protrusion 168 of the elastic structure 166 so as to deform the elastic structure 166. The protrusion 168 can not wedge in the sunken part 64 of the antenna body 62. That is, the elastic structure 166 releases the antenna body 62, and one end of the antenna body 62 can not be fixed inside the housing 54. The user can pull out the antenna body 62 in X direction. On the other hand, when the user wants to assemble the antenna body 62 into the housing 54, the antenna body 62 can be pushed in −X direction inwardly. At this time, the surface of the antenna body 62 pushes the protrusion 168 of the elastic structure 166 until the protrusion 168 wedges in the sunken part 64 so as to fix one end of the antenna body 62 inside the housing 54. The combination of the antenna body 62 and the elastic structure 166 is the elastic connection instead of the rigid connection so as to reduce difficulty of assembly of the antenna body 62.

In conclusion, the present invention utilizes the elastic structure to clamp the antenna body. The mechanism of the elastic structure for fixing the antenna body is not limited to above-mentioned embodiments. Any mechanism capable of combining the antenna body and the elastic structure elastically is within the scope of the present invention.

In contrast to the prior art, the present invention utilizes the elastic structure to fix the antenna body. The combination of the antenna body and the elastic structure is the elastic connection instead of the rigid connection, so the elastic structure can absorb impulsive force when collision of the antenna body occurs for reducing broken possibility of the antenna body. Furthermore, it can reduce difficulty of assembly of the antenna body and increase convenience of assembly of the antenna body.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable electronic device comprising:
a main body comprising:
a housing; and
a wireless communication module installed inside the housing for processing wireless signals; and
an antenna module connected to the housing at one end in a rotatable manner, the antenna module comprising:
an antenna body for receiving and radiating wireless signals, at least one sunken part being formed on the antenna body; and
at least one elastic structure fixed inside the housing and wedged in the sunken part on the antenna body in an elastic deformation manner so as to fix the antenna body and the housing.

2. The portable electronic device of claim 1 wherein the elastic structure comprising:
a spherical component wedged inside the sunken part so that the antenna body is capable of rotating relative to the housing; and
an elastic component connected to the spherical component for providing an elastic force to the spherical component so as to fix the spherical component inside the sunken part.

3. The portable electronic device of claim 2 wherein the elastic structure further comprises a fixing component fixed on the housing at one end for fixing the spherical component and the elastic component.

4. The portable electronic device of claim 3 wherein the fixing component is a sleeve, and the spherical component and the elastic component are installed inside the sleeve in a movable manner.

5. The portable electronic device of claim 4 wherein a diameter of an opening at one end of the sleeve is equal to or less than a diameter of the spherical component substantially.

6. The portable electronic device of claim 2 wherein the elastic component is a spring.

7. The portable electronic device of claim 6 wherein the spring and the spherical component are made of conductive material, and one end of the spring is electrically connected to the wireless communication module for transmitting wireless signals.

8. The portable electronic device of claim 6 wherein the spring and the spherical component are made of metal material.

9. The portable electronic device of claim 2 wherein the spherical component is a steel ball.

10. The portable electronic device of claim 2 wherein the sunken part is an arc indentation.

11. The portable electronic device of claim 1 wherein the elastic structure is a fragment whereon a protrusion is disposed for wedging inside the sunken part so that the antenna body is capable of rotating relative to the housing.

12. The portable electronic device of claim 1 wherein the protrusion is a spherical protrusion.

13. The portable electronic device of claim 12 wherein the sunken part is an arc indentation.

14. The portable electronic device of claim 11 wherein at least one wave structure is disposed on the fragment for reducing rigidity of the fragment.

15. The portable electronic device of claim 11 wherein the fragment is made of conductive material and electrically connected to the wireless communication module for transmitting wireless signals.

16. The portable electronic device of claim 15 wherein the fragment is made of metal material.

17. The portable electronic device of claim 1 wherein the housing is a housing of a display module.

18. The portable electronic device of claim 1 being a portable computer.

19. The portable electronic device of claim 18 being a tablet computer.
